(19) United States
(12) Patent Application Publication
(10) Pub. No.: US 2008/0245309 A1
(43) Pub. Date: Oct. 9, 2008

(54) Dog toilet

(76) Inventor: Douglas G. Markley, Overland Park, KS (US)

Correspondence Address: CHASE LAW FIRM L.C, 4400 COLLEGE BOULEVARD, SUITE 130, OVERLAND PARK, KS, 66211, US

(21) Appl. No.: 11/784,705

(22) Filed: Apr. 9, 2007

(51) Int. Cl. A01K 1/01

(52) U.S. Cl. 119/161

(57) ABSTRACT

A dog toilet is provided by a receptacle having a base and a rear wall and which presents an opening through which a dog may enter and leave the receptacle. The base presents a floor that has a drain opening therein adjacent the rear wall. A urinating post mounted above the drain opening and generally aligned therewith has a lower end in sufficiently close proximity to the drain opening to prevent a dog from stepping into the drain. A flushing system directs liquid along the floor to flush excrement to the drain opening when the dog leaves the receptacle.

This invention relates to improvements in receiving devices for collecting an animal waste product and, in particular, to a toilet for dogs that is designed to be installed indoors and used by household pets whenever the need arises and without human assistance.

### BACKGROUND OF THE INVENTION

Dogs and people have been friends for centuries. Despite the growth of cities and the change of people's habitats from rural to urban settings, and into suburban houses and apartments, dogs have remained a popular pet and have adapted to the indoors environment typical of a human dwelling. Most dogs now live indoors with their masters and, with that change, a major inconvenience has emerged for both dog and master in that the master must be available to see that the dog gets outside to discharge liquid and solid waste. Although dogs can be trained to use a dog door, a small door installed in an exterior door or wall which allows the dog to go in and out at will, this is only a partial solution. Dog doors are often drafty and energy inefficient and present a concern in that home security is compromised. Furthermore, regardless of the manner in which the dog gains access to the yard, the continued deposit of waste in the yard requires constant clean-up if a pleasant environment for people is to be maintained.

### SUMMARY OF THE INVENTION

In an embodiment of the present invention an improved dog toilet is provided for use indoors and provides a receptacle into which the dog may enter, and which is provided with (Docket 4045) an upright urinating post above a drain opening in the floor of the receptacle to particularly accommodate a male dog. The base of the receptacle presents a nearly flat and level floor, sloping slightly toward the drain opening, and a flushing system directs liquid along the floor to flush excrement to the drain opening when the dog leaves the receptacle.

Another aspect of the present invention is the utilization of a urinating post mounted in an upright position above the drain opening and generally aligned therewith, the lower end of the post being in sufficient proximity to the drain opening to prevent a dog from stepping into the drain.

Another aspect of the invention is the utilization of a urinating post having a horizontal dimension at least as great as the diameter of the drain opening to thereby prevent the dog from stepping into the drain.

Another aspect of the invention is the provision of a flushing system with a plurality of spaced nozzles along the floor of the receptacle for directing the flushing liquid along the floor for flow into the drain.

A further aspect of the invention is to provide a sensor in the receptacle responsive to the presence of a dog therein and connected with the flushing system for activating the flushing system when the dog leaves the receptacle.

Additionally, the present invention in another aspect thereof includes a grinder connected to the drain opening which discharges into a drain line. The grinder is responsive to activation of the flushing system to assure that waste does not clog the drain line and interfere with proper drainage.

Furthermore, an additional aspect of the invention is the provision of a dog toilet stall having a base, a rear wall and spaced sidewalls extending front to rear, and presenting an open front through which a dog may enter and leave the stall. The base presents a nearly flat and level floor sloping slightly toward the rear wall, and has a drain opening therein adjacent the rear wall. An elongated, upright urinating post is mounted in the stall above the drain opening in general alignment therewith, and has a lower end in sufficiently close proximity to the drain opening to prevent the dog from interfering with drainage. A flushing system directs water along the floor to flush liquid and solid waste to the drain opening, and is activated by a sensor in the stall responsive to the presence of a dog therein which activates the flushing system when the dog leaves the stall.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 is a perspective view of the dog toilet as seen from the front and side of the stall.

FIG. 2 is a diagrammatic, rear perspective view showing internal mechanical components of the toilet, the outline of the stall being shown in broken lines.

FIG. 3 is a front elevational view of the stall, the front wall thereof being broken away to reveal interior components.

FIG. 4 is a top plan view of the stall, the concentric drain opening and urinating post being shown in broken lines beneath the top panel.

FIG. 5 is an electrical schematic diagram of the flushing system.

### DETAILED DESCRIPTION

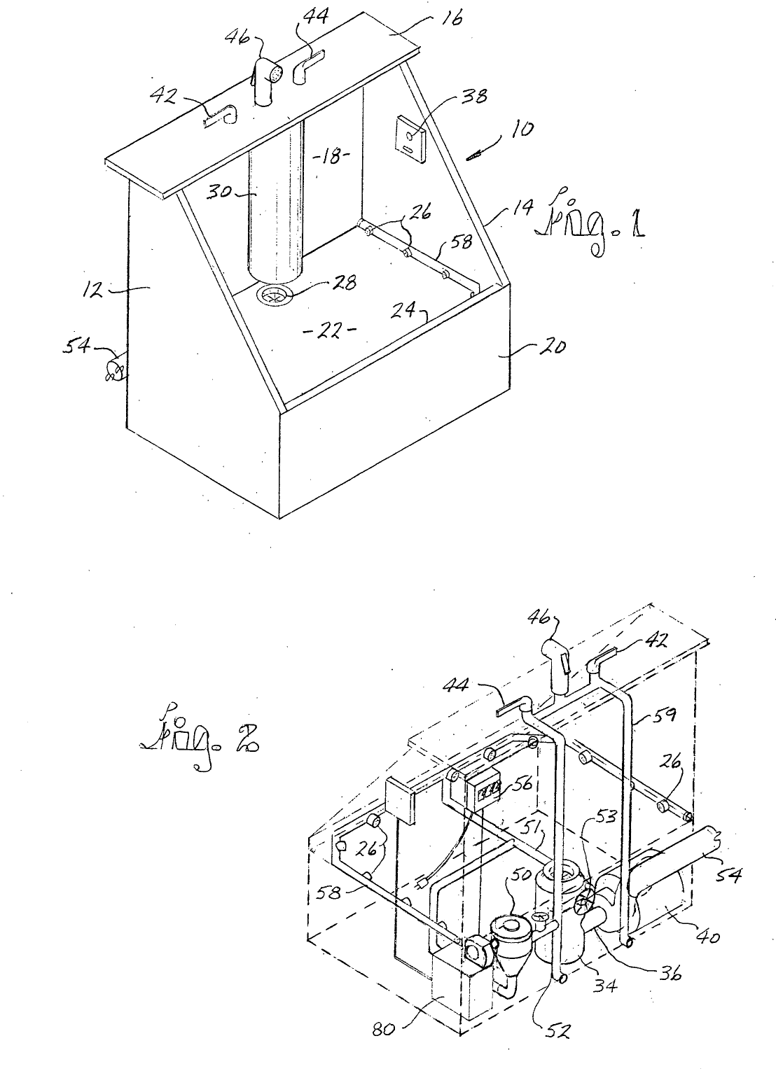

Referring initially to FIG. 1, a stall 10 is shown having spaced, left and right sidewalls 12 and 14, a top panel 16, a rear wall 18, and a front panel 20. The front panel 20 is substantially shorter in vertical height than rear wall 18 to permit a dog to enter the stall 10 over front panel 20 and onto an essentially flat floor 22, the front edge of which is spaced approximately two inches below the upper, horizontal edge or lip 24 of front panel 20, as shown in FIG. 3. A series of spaced nozzles 26 are disposed along the front and side edges of the floor 22 and form a part of the flushing system to be discussed. The floor 22 slopes slightly from front to rear and has drain opening 28 therein centered with respect to the sidewalls 12 and 14 and closely spaced from rear wall 18.

A urinating post 30 comprises a cylinder approximately eight inches in diameter secured at its upper end beneath top panel 16. The axis of the post 30 is aligned with the center of the drain opening 28, and the lower end 32 of post 30 is approximately three to four inches above drain opening 28. By aligning the urinating post 30 and the drain opening 28 on a common axis, and restricting the space between the top of drain opening 28 and the bottom end 32 of the post to approximately four inches or less, a dog using the toilet is prevented from stepping into the drain opening 28 during use of the stall. Post 30 is provided to accommodate male dogs by providing a surface similar to a tree trunk or fire hydrant for male dogs to urinate. The panels and walls of the stall are preferably of a fiberglass or plastic material so as to be completely waterproof and easy to clean.

Referring particularly to FIG. 3, the front panel 20 is broken away to reveal a grinder 34 which receives the waste flowing through drain opening 28 and assures that solid excrement will pass through the drain line 36 and ultimately to a sewer system in the same manner as other household waste water. The grinder may be a garbage disposal of the type commonly used under kitchen sinks. A typical household P-trap (not shown) is attached to the outlet of the grinder, from which the drain would be plumbed into the house drain line. In instances in which the waste must be moved vertically to an elevated drain line, an in-line centrifungal waste pump 40 (with a check valve) may be utilized to feed the waste to the elevated drain.

A standard commercial bathroom proximity sensor 38 is mounted on the interior of sidewall 14. As is conventional in sensors of this type, when the dog enters the stall by stepping over the front panel 20 and onto the floor 22, presence is sensed but no activation of the flushing system occurs until the dog finishes and exits the stall 10 over the front panel 20. The flushing system is then activated and water flows from nozzles 26 toward rear wall 18 due to the sloping floor 22, and then out the drain opening 28. To facilitate periodic thorough cleaning, the stall 20 may be provided with hot and cold water connections as represented by the valve handles 42 and 44 on top panel 16, and the nozzle end of a flexible hose 46 shown retracted (stored within post 30) but which may be withdrawn to clean and flush the floor 22 and walls 12, 14 and 18 as well as urinating post 30. Also, sensor 38 is provided with a button for manually initiating a flush sequence.

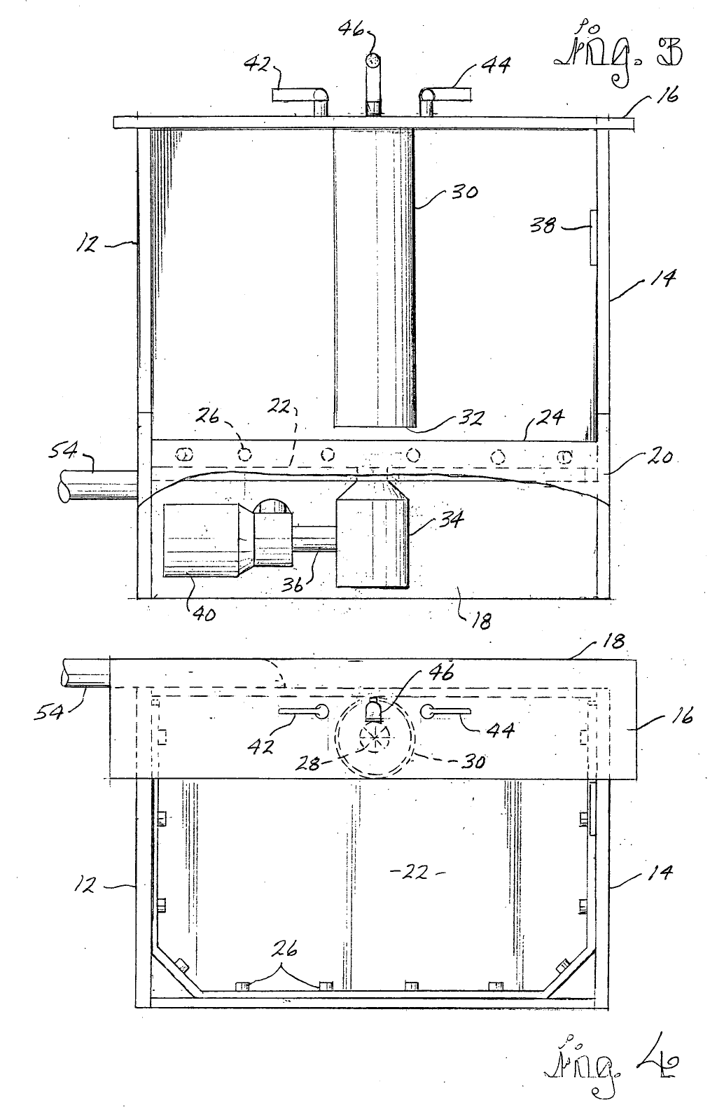

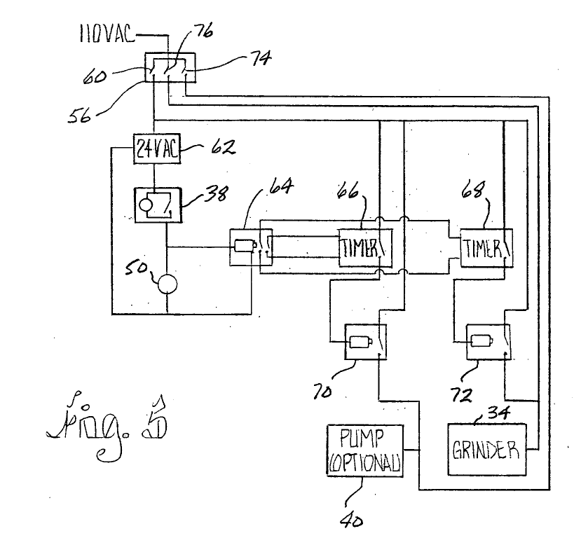

Other internal mechanical components of the toilet are illustrated in FIG. 2 and are located behind the rear wall 18 and underneath floor 22. An automatic flush valve 50 (responsive to activation by sensor 38) communicates with a cold water line 52 which also leads to the valve controlled by handle 44. Line 59 supplies hot water to the valve controlled by handle 42. A drain connection 54 extends from pump 40 and is provided with a check valve (not shown). A switch box 56 provides three switches for controlling the apparatus as will be described below with reference to FIG. 5. The spaced nozzles 26 of the flushing system are spaced along a pipe 58 that extends along the inner faces of front panel 20 and sidewalls 12 and 14 and connects back to flush valve 50. A bypass line 51 to cold water line 52 permits manual flushing by opening manual flush valve 53.

Referring to FIG. 5, a main power switch 60 provides 1.10 volts AC to a 24-volt transformer 62 which, in turn, powers the proximity sensor 38. When the sensor 38 closes its internal switch in response to the dog leaving the stall, flush valve 50 is activated to initiate flushing of the floor 22. An electromechanical relay 64 is also energized, closure of its contacts initiating the operation of a pump timer 66 and a grinder timer 68. The flush valve may be opened for approximately 8 seconds. Each of the timers 66 and 68 closes its associated switch to close power circuits to 110 volt relays 70 and 72 respectively. Closure of the contacts of relay 72 initiates operation of the grinder 34 and, as an option, relay 70 energizes pump 40 in installations in which a waste pump is required to feed the waste to an elevated drain. In normal operation, the grinder will continue in operation for a few seconds after the flush, and the pump (if installed) will continue yet a few more seconds so as to evacuate all products of the flush from the system. Individual manual control of pump 40 and grinder 34 is provided by switches 74 and 76 respectively. Transformer 62, timers 66 and 68, and relays 64, 70 and 72 are in a housing 80 (FIG. 2). The 110 volt circuits in FIG. 5 are illustrated by a single line, it being understood that the conventional electrical returns would be provided.

It is to be understood that while certain forms of an embodiment of this invention have been illustrated and described, it is not limited thereto, except insofar as such limitations are included in the following claims and allowable equivalents thereof.

Having thus described the invention, what is claimed as new and desired to be secured by Letters Patent is:

1. A dog toilet comprising:
a receptacle having a base and a rear wall and presenting an opening through which a dog may enter and leave the receptacle,
said base presenting a floor having a drain opening therein adjacent said rear wall,
an elongated, upright urinating post mounted in said receptacle above said drain opening and generally aligned therewith, and having a lower end in sufficiently close proximity to said drain opening to prevent a dog from stepping into the drain, and
a flushing system for directing liquid along said floor to flush excrement to said drain opening when a dog leaves the receptacle.

2. The dog toilet as claimed in claim 1, wherein said drain opening has a predetermined diameter, and said lower end of the urinating post has a horizontal dimension at least as great as said diameter to thereby prevent the dog from stepping into the drain.

3. The dog toilet as claimed in claim 1, wherein said flushing system includes a plurality of spaced nozzles along an edge of said floor away from said drain opening for directing said liquid along said floor.

4. The dog toilet as claimed in claim 1, further comprising structure communicating with said drain opening for receiving waste therefrom and including a pump for feeding the waste to an elevated drain.

5. A dog toilet comprising:
a receptacle having a base and a rear wall and presenting an opening through which a dog may enter and leave the receptacle,
said base presenting a floor having a drain opening therein adjacent said rear wall,
an elongated, upright urinating post mounted in said receptacle above said drain opening and generally aligned therewith, and having a lower end in sufficiently closely spaced relationship to said drain opening to prevent a dog from stepping into the drain,
a flushing system for directing liquid along said floor to flush excrement to said drain opening, and
a sensor in the receptacle responsive to the presence of a dog therein and connected with said flushing system for activating the flushing system when a dog leaves the receptacle.

6. The dog toilet as claimed in claim 5, wherein said flushing system includes a grinder connected to said drain opening, discharging to a drain line and responsive to activation of said flushing system.

7. A dog toilet comprising:
a stall having a base, a rear wall and spaced sidewalls extending front to rear, and presenting a front opening through which a dog may enter and leave the stall,
said base presenting a floor having a drain opening therein adjacent said rear wall,
an elongated, upright urinating post mounted in said stall above said drain opening and generally aligned therewith, and having a lower end in sufficiently closely spaced relationship to said drain opening to prevent a dog from stepping into the drain,
a flushing system for directing liquid along said floor to flush excrement to said drain opening, and
a sensor in the stall responsive to the presence of a dog therein and connected with said flushing system for activating the flushing system when a dog leaves the stall.
